(19) United States
(12) Patent Application Publication
(10) Pub. No.: US 2025/0276622 A1
(43) Pub. Date: Sep. 4, 2025

(54) SEAT ASSEMBLY

(71) Applicant: Lear Corporation, Southfield, MI (US)

(72) Inventors: Tomas Svitavsky, Pilzen (CZ); Tomas Bilek, Pilsen (CZ); Michaela Novakova, Pilsen (CZ); Abdessalam El Alaoui, Rabat (MA); Thomas Frank, Ismaning (DE)

(73) Assignee: Lear Corporation, Southfield, MI (US)

(21) Appl. No.: 19/057,368

(22) Filed: Feb. 19, 2025

(30) Foreign Application Priority Data
Mar. 4, 2024 (DE) 10 2024 106 186.3

(51) Int. Cl. B60N 2/427; B60N 2/07; B60N 2/90

(52) U.S. Cl. CPC B60N 2/42745; B60N 2/074; B60N 2/0745; B60N 2002/924

(57) ABSTRACT

A track assembly comprising a first track having a curved configuration; a second track slidably connected to the first track; a seat assembly connected to move with the second track, the seat assembly comprising a seat base and a seat back adjustable to a plurality of seat positions relative to the second track; a lock configured to selectively lock the first track and the second track; and a release lever configured to automatically actuate the lock.

### CROSS-REFERENCE TO RELATED APPLICATIONS

This applications claims priority to and the benefit of German Patent Application 10 2024 106 186.3, filed Mar. 4, 2024, the disclosure of which is hereby incorporated by reference in its entirety as though fully set forth herein.

### TECHNICAL FIELD

The present disclosure generally relates to seat assemblies, including seat assemblies that can, for example, be utilized in connection with vehicles.

### BRIEF DESCRIPTION OF THE DRAWINGS

While the claims are not limited to a specific illustration, an appreciation of various aspects may be gained through a discussion of various examples. The drawings are not necessarily to scale, and certain features may be exaggerated or hidden to better illustrate and explain an innovative aspect of an example. Further, the exemplary illustrations described herein are not exhaustive or otherwise limiting, and embodiments are not restricted to the precise form and configuration shown in the drawings or disclosed in the following detailed description. Exemplary illustrations are described in detail by referring to the drawings as follows:

FIG. 1 is a schematic view generally illustrating an embodiment of a seat assembly with a second track in a first position according to teachings of the present disclosure.

FIG. 2 is a schematic view generally illustrating an embodiment of a seat assembly with a second track in a second position according to teachings of the present disclosure.

FIG. 3 is a schematic view generally illustrating an embodiment of a seat assembly with a second track in a second position according to teachings of the present disclosure.

FIG. 4 is a schematic view generally illustrating an embodiment of a seat assembly in a first orientation with a second track in a first position according to teachings of the present disclosure.

FIG. 5 is a schematic view generally illustrating an embodiment of a seat assembly in a second orientation with a second track in a first position according to teachings of the present disclosure.

FIG. 6 is a schematic view generally illustrating an embodiment of a seat assembly in a second orientation with a second track in a second position according to teachings of the present disclosure.

FIG. 7 is a flow diagram generally illustrating an embodiment of a method of operating a seat assembly according to teachings of the present disclosure.

### DETAILED DESCRIPTION

Reference will now be made in detail to embodiments, examples of which are illustrated in the accompanying drawings. In the following detailed description, numerous specific details are set forth in order to provide a thorough understanding of the various described embodiments. However, it will be apparent to one of ordinary skill in the art that the various described embodiments may be practiced without these specific details. In other instances, well-known methods, procedures, components, circuits, and networks have not been described in detail so as not to unnecessarily obscure aspects of the embodiments.

Seat assemblies can be utilized in connection with vehicles that may experience crashes. Limiting the forces applied to occupants of the seat assemblies and/or limiting movement of the occupants during crashes is desirable. In some instances, the seat assemblies are not initially positioned in ideal positions for crashes, so automatically moving seat assemblies to positions that better limit forces applied to occupants and/or better limit movement of occupants is desirable.

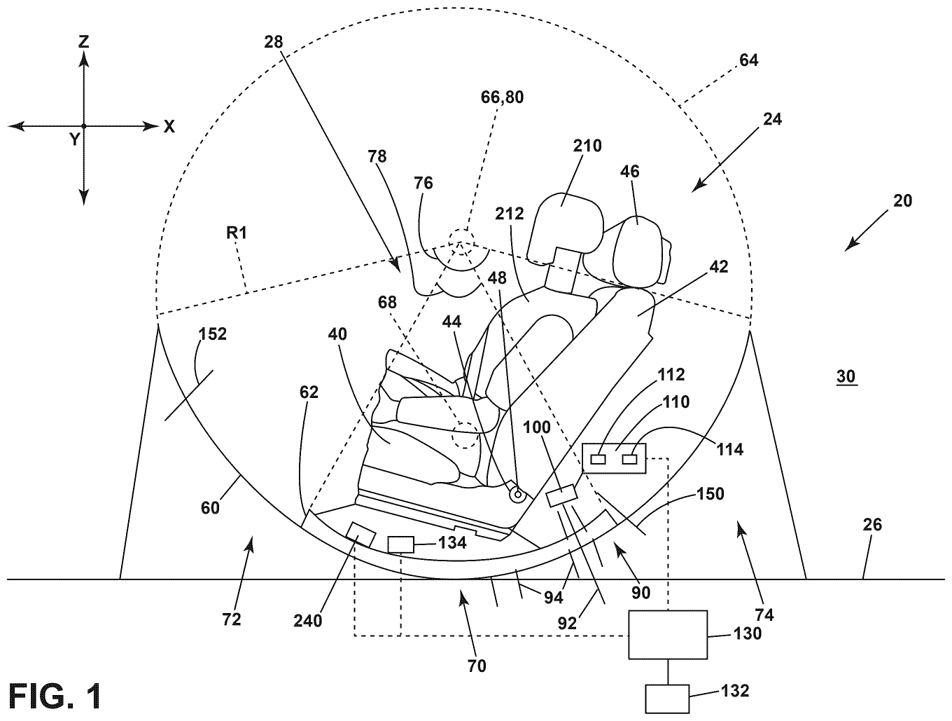

Referring to FIG. 1, a track assembly 20 includes a seat assembly 24 connected to a mounting surface 26 via a first track 60 and a second track 62. An occupant 28 is shown seated on the seat assembly 24. The seat assembly 24 includes a seat base 40 and a seat back 42. At least one of the seat base 40 or the seat back 42 is rotatable relative to the other. For example, the seat back 42 is rotatable relative to the seat base 40 about a seat back axis 48 (e.g., a recliner axis) to provide various reclined positions for the occupant 28, such as via a recliner 44. The seat back axis 48 is parallel with the mounting surface 26 and perpendicular to the direction the seat assembly 24 is facing. The seat assembly 24 includes a head restraint 46 connected to a top of the seat back 42. The track assembly 20 is shown in a vehicle 30, but can be utilized in other applications.

The second track 62 slidably connected to the first track 60. The first track 60 includes a curved configuration with a radius R1 and is mounted to the mounting surface 26. The first track 60 is parallel with an X-Z plane and is curved such that a distance in the Z-direction of the first track 60 from the mounting surface 26 varies along the X-direction. The first track 60 includes a middle section 70 that is disposed closest to the mounting surface 26, a front section 72 that curves forward and upward from the middle section 70, and a rear section 74 that curves rearward and upward from the middle section 70. An angular extent 76 of the first track 60 can, for example, be at least 30 degrees and less than or equal to 180 degrees, at least 30 degrees and less than or equal to 120 degrees, at least 30 degrees and less than or equal to 90 degrees, or at least 40 degrees and less than or equal to 50 degrees, among others. The angular extent 78 of the second track 62 is less than the angular extent 76 of the first track 60, which can include the angular extent 78 being at least 50% and less than or equal to 90% of the angular extent 76. For example, the angular extent 78 can be at least 25 degrees and less than or equal to 40 degrees. The first track 60 is sufficiently longer than the second track 62 to allow sliding movement of at least 10 degrees, and, at least with some configurations, at least 30 degrees. The extent of sliding movement of the second track 62 is less than the angular extent 76 of the first track 60, such as by at least 10 degrees, and can be determined via positioning of one or more end stops 150, 152. The radius R1 of the first track 60 can, for example, be at least 300 mm (11.8 in) and less than or equal to 900 mm (35.4 in), or less than 300 mm or greater than 900 mm. With some examples, the radius R1 can be 600 mm, which can result in 10 degrees of angular movement of the second track 62 for every 100 mm of circumferential displacement along the first track 60 (e.g., 200 mm of circumferential displacement would result in 20 degrees of angular movement).

A center 66 of a circle 64 partially defined by the first track 60 and having the radius R1 defines a rotational axis 80 about which the second track 62 and the seat assembly 24 connected thereto rotate. The seat base 40 and the seat back 42 are positioned such that an expected center of gravity 68 of the occupant 28 is disposed above the second track 62 and below (e.g., closer to the mounting surface 26) the center 66 of the circle 64 and the rotational axis 80. Such a configuration, with the center of gravity 68 offset vertically below the center 66 and the rotational axis 80, tends to cause the seat assembly 24 to rotate about the rotational axis 80 during a crash.

The track assembly 20 includes a lock 90 that is configured to selectively lock the first track 60 and the second track 62. The lock 90 is connected to the second track 62 to selectively engage the first track 60 to selectively allow and prevent sliding movement of the second track 62 along the first track 60. The lock 90 can, for example, include one or more pins 92 movable in the radial direction to selectively engage corresponding apertures 94 of the first track 60. The apertures 94 are spaced along the first track 60, such as to provide various rotational seat positions.

The track assembly 20 includes a release lever 100 configured to automatically unlock the lock 90. The release lever 100 is operably coupled to the lock 90 such that operation of the release lever 100 unlocks the lock 90, unlocking the second track 62 from the first track 60 to allow sliding movement of the second track 62, or locks the lock 90, locking the second track 62 with the first track 60 to prevent sliding movement of the second track 62.

The track assembly 20 includes an actuator 110 operably coupled with the release lever 100, such as to automatically actuate (e.g., lock, unlock, or both) the lock 90. The actuator 110 includes a mechanical actuator 112, a powered actuator 114, or both. The mechanical actuator 112 can include, for example, a mass configured to move when certain forces are applied to the mass, such as crash forces during a vehicle crash. For example, in the event of a crash, the crash forces cause movement of the mass, which actuates the release lever 100 to unlock the lock 90. The mechanical actuator 112 may operate without an external power source (e.g., electrical power, fluid power, etc.). The powered actuator 114 can include, for example, at least one of a motor, an electromagnet, a piezoelectric material, a cylinder, or a pyrotechnic device. The powered actuator 114 can additionally include a mechanical actuator.

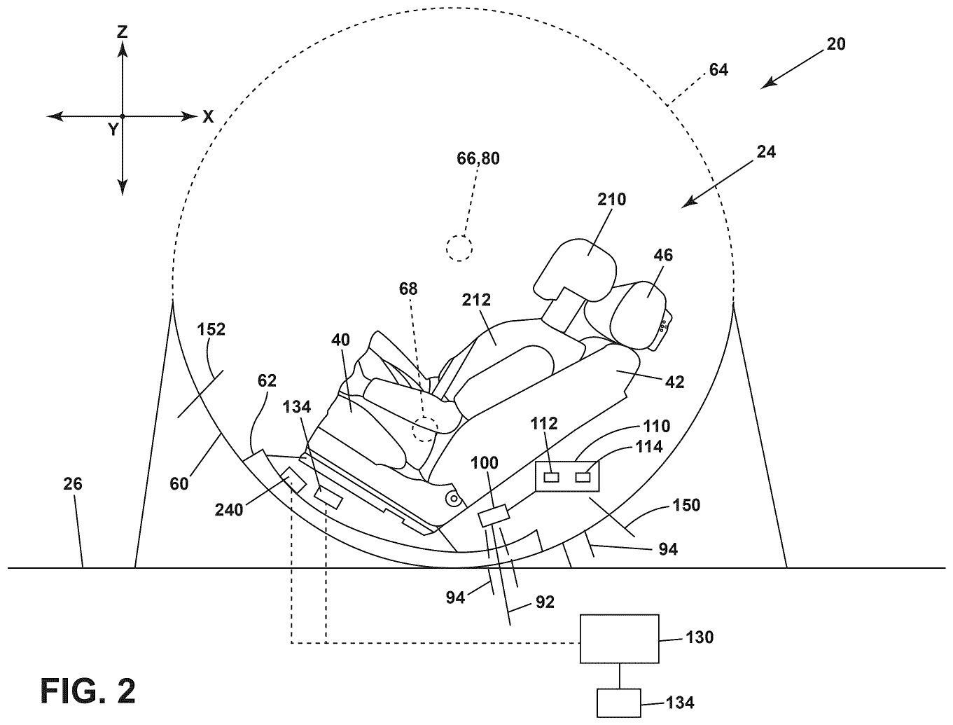

The track assembly 20 includes a controller 130 and a crash sensor 132. The controller 130 is in communication with the powered actuator 114, the crash sensor 132, and/or a track motor 240. The controller 130 controls, at least in part, operation of the powered actuator 114, such as in response to receiving information from the crash sensor 132 that a crash has occurred or is imminent. For example, when the crash sensor 132 senses that a crash has occurred or is imminent, the controller 130 controls the powered actuator 114 to operate the release lever 100 to unlock the lock 90 and allow crash forces and/or momentum to cause the second track 62 to move along the first track 60 from a second position (e.g., a reclined position), such as shown in FIG. 2, to a first position, such as shown in FIG. 1. Additionally or alternatively, the controller 130 is configured to operate the powered actuator 114 to operate the release lever 100 to lock the lock 90 when the second track 62 reaches the first position. The crash forces and/or momentum may allow for a greater rate of position adjustment than is feasible via an actuator (e.g., the track motor 240) coupled to move the second track 62 along the first track 60. For example, a motor powerful enough to move the second track 62 at a rate comparable to the crash forces/momentum may be too large to fit the available space, may be heavier than desired, and/or may consume more electrical power than available or desired. Additionally or alternatively, utilizing at least some of the crash forces/momentum to move the second track 62 may reduce the forces applied to the occupant 28. The crash sensor 132 can include one or more of a variety of configurations, such as an accelerometer, radar, lidar, others, or combinations thereof.

The track assembly 20 optionally includes a track position sensor 134 configured to sense a position of the second track 62 relative to the first track 60. The controller 130 can utilize information from the track position sensor 134 to determine whether to actuate the powered actuator 114 to actuate the release lever 100 to lock or unlock the lock 90. For example, in accordance with the track position sensor 134 indicating that the second track 62 is not in the first position (e.g., the crash position) and the crash sensor 132 indicates a rear crash, the controller 130 operates the powered actuator 114 to actuate the release lever 100 to unlock the lock 90 and allows the second track 62 to move toward or to the first position, such as via the crash forces. Additionally or alternatively, in accordance with the track position sensor 134 indicating that the second track 62 is already in the first position with a rear crash, the controller 130 actuates the powered actuator 114 to actuate the release lever 100 to lock the lock 90 or maintains the status of the powered actuator 114 and/or the release lever 100 to keep the lock 90 locked.

A corresponding operation for a front crash can also be utilized. For example, in accordance with the track position sensor 134 indicating that the second track 62 is not in the second position and the crash sensor 132 indicates a front crash, the controller 130 operates the powered actuator 114 to actuate the release lever 100 to unlock the lock 90 and allows the second track 62 to move toward or to the second position, such as via the crash forces. Additionally or alternatively, in accordance with the track position sensor 134 indicating that the second track 62 is already in the second position with a front crash, the controller 130 actuates the powered actuator 114 to actuate the release lever 100 to lock the lock 90 or maintains the status of the powered actuator 114 and/or the release lever 100 to keep the lock 90 locked.

The second position can, for example, include a zero-gravity position or a slouched position. The first position can, for example, include a design or driving position in which the seat base 40 is closer to parallel with the mounting surface 26 and/or in which the seat back 42 is closer to perpendicular to the mounting surface 26, which may be better suited for protecting the occupant 28 during certain crashes (e.g., rear crashes) than the second position. Additionally or alternatively, the second position may be better suited for protecting the occupant 28 during certain other crashes (e.g., front crashes) than the first position.

The track assembly 20 includes a first end stop 150 and a second end stop 152 that limit sliding movement of the second track 62 along the first track 60 (e.g., rotational movement of the seat assembly 24 about the rotational axis 80). The first end stop 150 is disposed in the rear section 74 of the first track 60, such as at or spaced from the rear end of the rear section 74. The second end stop 152 is disposed in the front section 72 of the first track 60, such as at or spaced from the front end of the front section 72. The first end stop 150 limits movement of the second track 62 in a first rotational direction (e.g., counterclockwise in FIG. 2), which is generally rearward and upward relative to the first track 60. The second end stop 152 limits movement of the second track 62 in a second rotational direction (e.g., clockwise in FIG. 2), which is generally forward and upward relative to the first track 60. Optionally, the first end stop 150 is aligned with the first position of the second track 62 such that movement of the second track 62 (e.g., during a crash) is automatically stopped at the first position by contacting the first end stop 150, such as in addition to or instead of the controller 130 operating the powered actuator 114 (e.g., if the track assembly 20 includes the mechanical actuator 112 and not the powered actuator 114).

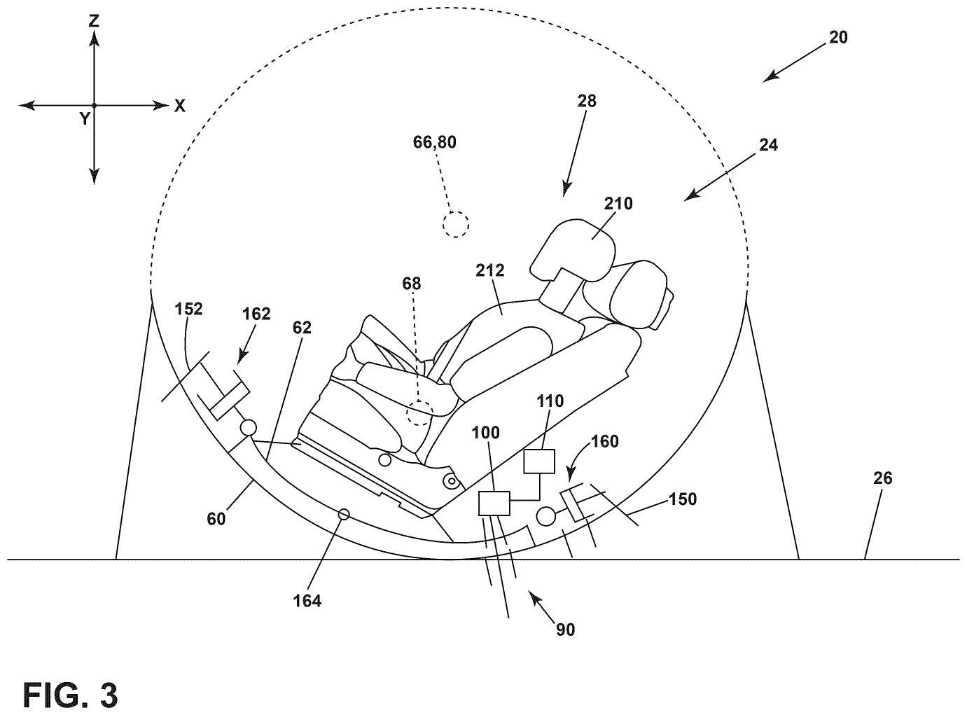

Referring to FIG. 3, the track assembly 20 is shown with a first damper 160 at the first end stop 150 and a second damper 162 at the second end stop 152. The first damper 160 absorbs at least some of the force from the second track 62 as the second track 62 moves to the first end stop 150, which can include crash forces. The second damper 162 absorbs at least some of the force from the second track 62 as the second track 62 moves to the second end stop 152. While the first and second dampers 160, 162 are shown at the first and second end stops 150, 152, the first damper 160 and/or the second damper 162 can be coupled to move with the second track 62 and engage the first end stop 150 and the second end stop 152, respectively. The track assembly 20 is also shown with a track damper 164. The track damper 164 is coupled to the first track 60 or the second track 62 to contact the other of the first track 60 or the second track 62 as the second track 62 moves along the first track 60, such as to limit the speed of the second track 62 (e.g., via friction). The dampers 160, 162, 164 may limit forces applied to the occupant 28.

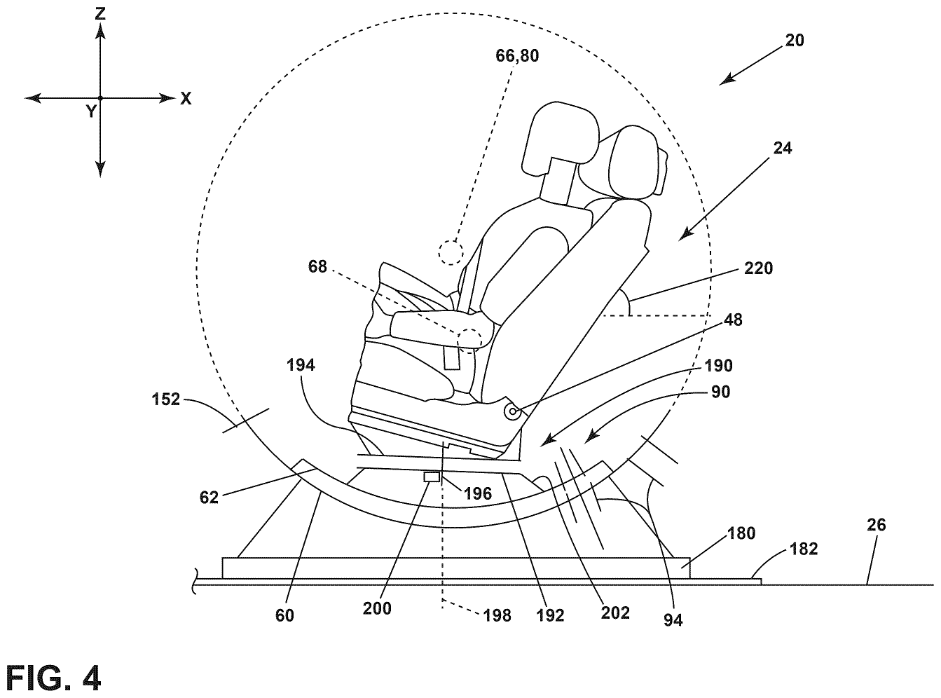

Referring to FIG. 4, the track assembly 20 is shown with a third track 180 and a fourth track 182 that mount the first track 60 to the mounting surface 26. The third track 180 is slidably connected to the fourth track 182, which is mounted to the mounting surface 26. The first track 60 is mounted to move with the third track 180 along the fourth track 182. The third track 180 and the fourth track 182 have linear configurations that are parallel with the longitudinal direction X. For example, the third track 180 and the fourth track 182 provide longitudinal adjustment for the seat assembly 24 in addition to the rotational adjustment of the seat assembly 24 provided via the first track 60 and the second track 62 and/or the rotational adjustment of the seat back 42, such as via the recliner 44.

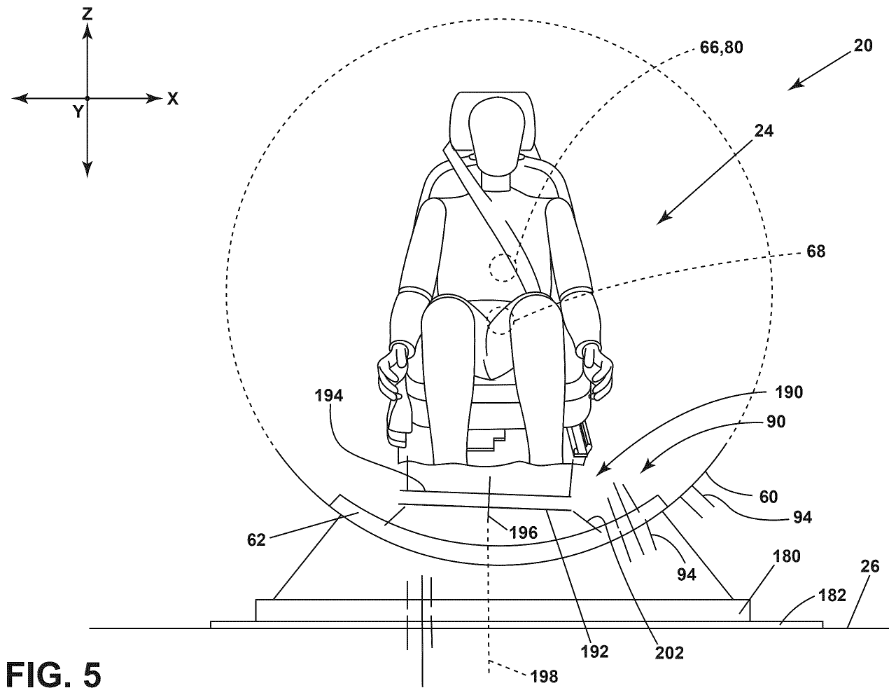

The track assembly 20 is shown with a frame 190 including a first frame portion 192 and a second frame portion 194. The first frame portion 192 is coupled with the second track 62. The second frame portion 194 is coupled with the seat assembly 24. A pivot 196 rotatably couples the first frame portion 192 with the second frame portion 194 such that the seat assembly 24 is rotatable relative to the second track 62 about a seat axis 198. The seat axis 198 extends in an X-Z plane and/or is perpendicular to the rotational axis 80, which can be parallel with the lateral direction Y (e.g., the seat assembly 24 can be rotatable about two axes that are perpendicular to each other). Additionally or alternatively, the seat axis 198 is perpendicular to the second track 62 and/or not parallel with the seat back axis 48. When the second track 62 is in the first position, the seat axis 198 can be parallel or close to parallel with the vertical direction Z. The pivot 196 allows the seat assembly 24 to rotate relative to the second track 62, such as between a forward-facing orientation shown in FIG. 4, with the seat assembly 24 facing the longitudinal direction X, and one or more other orientations, such as the lateral-facing orientation shown in FIG. 5 in which the seat assembly 24 is facing the lateral direction Y. The rotational orientations of the seat assembly 24 relative to the second track 62 are not limited to facing the longitudinal and lateral directions X, Y, and can include positions between the longitudinal and lateral directions X, Y. The pivot 196 can be operated manually, can include or be coupled to a motor 200 for powered adjustment, or both. While the frame 190 and the pivot 196 are shown as rotatably coupling the seat assembly 24 with the second track 62, the frame 190 and/or the pivot 196 can rotatably connect the first track 60 with the third track 180 or rotatably connect the fourth track 182 with the mounting surface 26. In some configurations, the frame 190 can adjust the height of the seat assembly 24. For example, one or both of the first frame portion 192 or the second frame portion 194 can include rotatable links 202.

The seat back 42 is rotatable about the seat back axis 48, the rotational axis 80, and the seat axis 198. The seat back axis 48 and the rotational axis 80 are parallel and offset such that rotation of the seat back 42 about either or both axes modifies a recline angle 220 (FIG. 4) of the seat back 42 relative to the mounting surface 26. In some examples, the recline angle 220 of the seat back 42 is adjustable by at least 10 degrees and less than or equal to 90 degrees via movement about the rotational axis 80.

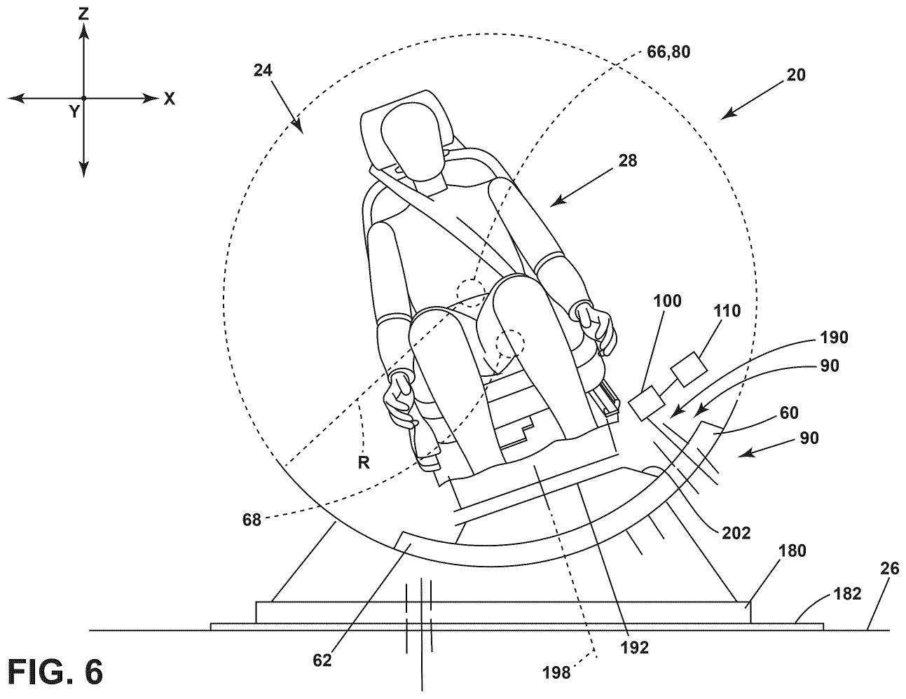

Referring to FIG. 6, the seat assembly 24 can rotate about the seat axis 198 and the rotational axis 80. For example, the occupant 28 may rotate the seat assembly 24 about the seat axis 198 to reorient the seat assembly 24 to face a different part of the vehicle 30, such as toward another occupant. In the event of a crash, the actuator 110 automatically unlocks the lock 90 and the crash forces cause the seat assembly 24 to rotate about the rotational axis 80 (e.g., counterclockwise in FIGS. 5 and 6), such as from the position shown in FIG. 5 to the position shown in FIG. 6. The rotation about the rotational axis 80 includes sliding movement of the second track 62 along the first track 60.

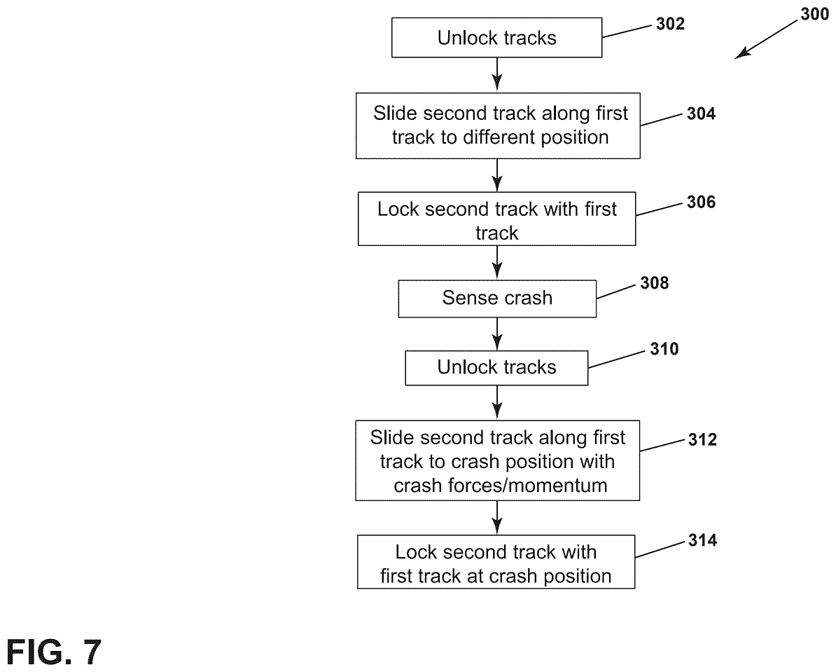

Referring to FIG. 7, a method 300 of operating a track assembly 20 includes unlocking the first and second tracks 60, 62 (block 302), and sliding the second track 62 along the first track 60 from an initial track position to a different track position, the first track 60 and the second track 62 having curved configurations (block 304). The method 300 includes locking the second track 62 with the first track 60 at the second track position (block 306), such as via the lock 90. The method 300 includes sensing a crash (block 308) and unlocking the second track 62 from the first track 60 in response to sensing the crash (block 310). The crash 308 can be sensed via the crash sensor 132. Additionally or alternatively, the mechanical actuator 112 may function as a crash sensor and perform both of blocks 308 and 310. The method 300 includes sliding the second track 62 along the first track 60 to a crash position utilizing momentum from the crash (block 312), and locking the second track 62 in the crash position (block 314), which can include automatically locking the second track 62 at the crash track position. If the crash is a rear crash, the crash position can include the first track position in which the seat assembly 24 and the occupant 28 are more upright. If the crash is a front crash, the crash position can include the second track position in which the seat assembly 24 and the occupant 28 are closer to horizontal. For example, the controller 130 may dynamically determine the crash position as the first track position or the second track position according to whether the sensed crash is a rear crash or a front crash, respectively.

The first end stop 150 may automatically stop the second track 62 at the first position, such as to facilitate the locking in block 312. Sliding the second track 62 to or toward the first track position can include the second track moving rearward and upward, or the second track 62 moving forward and upward, such as depending on the angle of impact. For example, with a rear crash, the second track 62 may slide rearward and upward toward the first position, and with a front crash, the second track 62 may slide forward and upward toward the second position.

Automatically locking the second track 62 can be conducted via the mechanical actuator 112, via the powered actuator 114, or a combination thereof. For example, the controller 130 may actuate (e.g., release) the release lever 100 such that the release lever 100 causes or allows the lock 90 to return to a locked state when the second track 62 reaches the first track position. The seat back 42 and the head restraint 46 are more upright in the first track position than in the second track position.

The method 300 can, with some configurations, function as a method of limiting movement of a head 210 of the occupant 28. For example, with the second track 62 in the first track position, the head restraint 46 of the seat assembly 24 is positioned to limit movement of the head 210 of the occupant 28 to a greater extent than with the second track 62 in the second track position. During a crash, the head restraint 46 can limit movement of the head 210 of the occupant 28 and the seat back 42 can limit movement of a torso 212 of the occupant 28. In the second position of the second track 62, the seat back 42 and/or the head restraint 46 may be closer to parallel with the mounting surface 26, which may limit movement of the torso 212 and the head 210, respectively, to a lesser extent than when the second track 62 is in the first position and the seat back 42 and the head restraint 46 are closer to perpendicular to the mounting surface 26.

The method 300 can be carried out, at least in part, via the controller 130. For example, the controller 130 may receive occupant input to move the second track 62 along the second track 62 from the first position to the second position, control the actuator 110 to unlock the tracks 60, 62 (block 302), control a track motor 240 (FIG. 1) to cause the sliding movement, and control the actuator 110 to lock the tracks 60, 62 at the second position. The controller 130 may determine the crash has occurred or is imminent via the crash sensor 132 (block 308), unlock the tracks 60, 62 (block 310), such as to allow the sliding movement in block 312, and then control the actuator 110 to lock the tracks 60, 62 when the second track 62 reaches the first track position (block 314).

With the method 300, blocks 302-306 can be utilized for comfort adjustments of the seat assembly 24, such as to improve the comfort of the occupant 28, and blocks 310-314 can be utilized for crash adjustments of the seat assembly 24, such as to improve the safety of the occupant 28 when a crash is sensed in block 308.

The instant disclosure includes the following non-limiting embodiments:

A track assembly, comprising: a first track having a curved configuration; a second track slidably connected to the first track; a seat assembly connected to move with the second track, the seat assembly comprising a seat base and a seat back adjustable to a plurality of seat positions relative to the second track; a lock configured to selectively lock the first track and the second track; and a release lever configured to automatically actuate the lock.

The track assembly of any preceding embodiment, wherein an angular extent of the first track is at least 30 degrees and less than or equal to 120 degrees.

The track assembly of any preceding embodiment, wherein the angular extent of the first track is at least 40 degrees and less than or equal to 50 degrees.

The track assembly of any preceding embodiment, further comprising a mechanical actuator operably coupled with the release lever to automatically unlock the lock.

The track assembly of any preceding embodiment, further comprising an actuator operably coupled with the release lever to automatically unlock the lock, the actuator including at least one of a motor, an electromagnet, a piezoelectric material, or a pyrotechnic device.

The track assembly of any preceding embodiment, further comprising an electronic controller controlling operation of the actuator.

The track assembly of any preceding embodiment, further comprising a crash sensor connected to the electronic controller; wherein the electronic controller is configured to operate the actuator to actuate the release lever and disengage the lock in accordance with the crash sensor detecting a crash.

The track assembly of any preceding embodiment, wherein the seat assembly is rotatable about a first axis via the second track sliding along the first track, and is rotatable about a second axis via a pivot rotatably coupling the seat assembly with the second track; and the second axis is perpendicular to the second track and not parallel with a seat back axis about which the seat back is adjustable.

The track assembly of any preceding embodiment, further comprising a third track slidably connected to a fourth track, the fourth track having a linear configuration; wherein the first track is mounted to the third track.

The track assembly of any preceding embodiment, wherein the seat back is adjustable about a seat back axis and is adjustable about a rotational axis that is offset from the seat back axis such that a recline angle of the seat back is adjustable via movement of the seat back about the seat back axis and via movement of the seat assembly about the rotational axis.

The track assembly of any preceding embodiment, wherein an angular extent of the second track is less than the angular extent of the first track.

The track assembly of any preceding embodiment, wherein the angular extent of the second track is at least 25 degrees and less than or equal to 40 degrees.

The track assembly of any preceding embodiment, wherein the first track has a radius of at least 300 mm and less than or equal to 900 mm.

The track assembly of any preceding embodiment, further comprising an electronic controller controlling operation of the actuator.

The track assembly of any preceding embodiment, further comprising a crash sensor connected to the electronic controller; wherein the electronic controller is configured to operate the actuator to actuate the release lever and disengage the lock in accordance with the crash sensor detecting a crash.

The track assembly of any preceding embodiment, wherein the electronic controller is configured to operate the actuator to reengage the lock when the second track reaches a crash position.

The track assembly of any preceding embodiment, further comprising a track position sensor sensing a position of the second track relative to the first track.

The track assembly of any preceding embodiment, wherein the electronic controller is configured to operate the actuator to reengage the lock according, at least in part, to the position of the second track obtained via the track position sensor.

The track assembly of any preceding embodiment, wherein the first track includes a first end stop and a second end stop that limit rotational movement of the seat assembly.

The track assembly of any preceding embodiment, wherein the first track comprises a damper disposed at the first end stop or the second end stop.

The track assembly of any preceding embodiment, wherein the second track includes a damper configured to engage the first end stop or the second end stop.

The track assembly of any preceding embodiment, wherein the seat assembly is rotatable about a first axis via the second track sliding along the first track, and is rotatable about a second axis via a pivot rotatably coupling the seat assembly with the second track.

The track assembly of any preceding embodiment, further comprising a third track slidably connected to a fourth track, the fourth track having a linear configuration; wherein the first track is mounted to the third track.

The track assembly of any preceding embodiment, wherein the seat back is adjustable about a seat back axis and is adjustable about a rotational axis that is offset from the seat assembly axis such that a recline angle of the seat back is adjustable via movement of the seat back about the seat back axis and via movement of the seat back about the rotational axis.

The track assembly of any preceding embodiment, wherein the angle of the seat back is adjustable by at least 10 degrees and less than or equal to 90 degrees via movement of the seat back about the track assembly axis.

A vehicle, comprising: a mounting surface; and the track assembly of any preceding embodiment, coupled to the mounting surface.

The vehicle of any preceding embodiment, wherein the seat assembly is rotatable about two axes that are perpendicular to each other.

The vehicle of any preceding embodiment, wherein the track assembly comprises a third track slidably connected to a fourth track that is mounted to the mounting surface and has a linear configuration; and the first track is mounted to third track.

A method of operating a track assembly, the method comprising: sliding a second track along a first track to a first track position, the first track having a curved configuration; locking the second track with the first track at the first track position; sensing a crash; unlocking the second track from the first track in response to sensing the crash; sliding the second track along the first track to a second track position utilizing momentum from the crash; and locking the second track in the second track position.

The method of any preceding embodiment, wherein the first track includes a first end stop and a second end stop; and the second track position is at the first end stop or the second end stop.

The method of any preceding embodiment, wherein a seat assembly is connected to the second track and includes a seat base and a seat back; and the seat back is more upright in the second track position than the first track position.

The method of any preceding embodiment, further comprising damping, via a damper, the sliding of the second track to the second track position.

The method of any preceding embodiment, wherein the damper is disposed at the first end stop or the second end stop.

The method of any preceding embodiment, further comprising, after sliding the second track to the second track position, limiting movement of a head of an occupant of the seat assembly via a head restraint of the seat assembly.

The method of any preceding embodiment, wherein sliding the second track to the second track position includes the second track moving rearward and upward.

The method of any preceding embodiment, wherein sliding the second track to the second track position includes the second track moving forward and upward.

The method of any preceding embodiment, comprising, prior to sensing the crash and sliding the second track to the second track position, rotating a seat coupled to the second track from a forward orientation to a transverse orientation.

A method of limiting movement of a head of an occupant of a vehicle seat assembly during a crash, the method comprising: sliding a second track along a first track from an initial track position to a different track position, the first track having a curved configuration; locking the second track with the first track at the different track position; sensing the crash; automatically unlocking the second track from the first track in response to sensing the crash; sliding the second track along the first track to a crash position utilizing momentum from the crash; and locking the second track in the crash position.

The method of any preceding embodiment, wherein, in the first track position, a head restraint of the vehicle seat assembly is positioned to limit movement of the head of the occupant to a greater extent than with the second track in the second track position.

A method of limiting movement of a head of an occupant of a vehicle seat assembly during a crash, the method comprising: sliding a second track along a first track from an initial track position to a different track position, the first track having a curved configuration; locking the second track with the first track at the different track position; sensing the crash; automatically unlocking the second track from the first track in response to sensing the crash; sliding the second track along the first track from the track position to a crash position utilizing momentum from the crash; and locking the second track in the crash position; wherein, in the crash position, a head restraint of the vehicle seat assembly is positioned to limit movement of the head of the occupant to a greater extent than with the second track in the track position.

An electronic controller configured to implement the method of any preceding embodiment.

A non-transitory computer-readable storage medium having a computer program encoded thereon for implementing the method of any preceding embodiment.

In examples, a controller (e.g., the electronic controller 130) may include an electronic controller and/or include an electronic processor, such as a programmable microprocessor and/or microcontroller. In embodiments, a controller may include, for example, an application specific integrated circuit (ASIC) and/or an embedded controller. A controller may include a central processing unit (CPU), a memory (e.g., a non-transitory computer-readable storage medium), and/or an input/output (I/O) interface. A controller may be configured to perform various functions, including those described in greater detail herein, with appropriate programming instructions and/or code embodied in software, hardware, and/or other medium. In embodiments, a controller may include a plurality of controllers. In embodiments, a controller may be connected to a display, such as a touchscreen display.

Various examples/embodiments are described herein for various apparatuses, systems, and/or methods. Numerous specific details are set forth to provide a thorough understanding of the overall structure, function, manufacture, and use of the examples/embodiments as described in the specification and illustrated in the accompanying drawings. It will be understood by those skilled in the art, however, that the examples/embodiments may be practiced without such specific details. In other instances, well-known operations, components, and elements have not been described in detail so as not to obscure the examples/embodiments described in the specification. Those of ordinary skill in the art will understand that the examples/embodiments described and illustrated herein are non-limiting examples, and thus it can be appreciated that the specific structural and functional details disclosed herein may be representative and do not necessarily limit the scope of the embodiments.

Reference throughout the specification to “examples, “in examples,” “with examples,” “various embodiments,” “with embodiments,” “in embodiments,” “an embodiment,” “with some configurations,” “in some configurations,” or the like, means that a particular feature, structure, or characteristic described in connection with the example/embodiment is included in at least one embodiment. Thus, appearances of the phrases “examples, “in examples,” “with examples,” “in various embodiments,” “with embodiments,” “in embodiments,” “an embodiment,” “with some configurations,” “in some configurations,” or the like, in places throughout the specification are not necessarily all referring to the same embodiment. Furthermore, the particular features, structures, and/or characteristics may be combined in any suitable manner in one or more examples/embodiments. Thus, the particular features, structures, or characteristics illustrated or described in connection with one embodiment/example may be combined, in whole or in part, with the features, structures, functions, and/or characteristics of one or more other embodiments/examples without limitation given that such combination is not illogical or non-functional. Moreover, many modifications may be made to adapt a particular situation or material to the teachings of the present disclosure without departing from the scope thereof. The word “exemplary” is used herein to mean “serving as a non-limiting example.”

It should be understood that references to a single element are not necessarily so limited and may include one or more of such element, unless the context clearly indicates otherwise. Any directional references (e.g., plus, minus, upper, lower, upward, downward, left, right, leftward, rightward, top, bottom, above, below, vertical, horizontal, clockwise, and counterclockwise) are only used for identification purposes to aid the reader's understanding of the present disclosure, and do not create limitations, particularly as to the position, orientation, or use of examples/embodiments.

“One or more” includes a function being performed by one element, a function being performed by more than one element, e.g., in a distributed fashion, several functions being performed by one element, several functions being performed by several elements, or any combination of the above. The term “at least one of” in the context of, e.g., “at least one of A, B, and C” or “at least one of A, B, or C” includes only A, only B, only C, or any combination or subset of A, B, and C, including any combination or subset of one or a plurality of A, one or a plurality of B, and one or a plurality of C.

Although the terms first, second, etc. are, in some instances, used herein to describe various elements, these elements should not be limited by these terms. These terms are only used to distinguish one element from another. For example, a first element could be termed a second element, and, similarly, a second element could be termed a first element, without departing from the scope of the various described embodiments. The first element and the second element are both elements, but they are not the same element.

The terminology used in the description of the various described embodiments herein is for the purpose of describing particular embodiments only and is not intended to be limiting. As used in the description of the various described embodiments and the appended claims, the singular forms “a”, “an” and “the” are intended to include the plural forms as well, unless the context clearly indicates otherwise. The term “and/or” as used herein refers to and encompasses any and all possible combinations of one or more of the associated listed items. Uses of “and” and “or” are to be construed broadly (e.g., to be treated as “and/or”). For example and without limitation, uses of “and” do not necessarily require all elements or features listed, and uses of “or” are inclusive unless such a construction would be illogical. The terms “includes,” “including,” “comprises,” and/or “comprising,” when used in this specification, specify the presence of stated features, integers, steps, operations, elements, and/or components, but do not preclude the presence or addition of one or more other features, integers, steps, operations, elements, components, and/or groups thereof.

Joinder references (e.g., attached, coupled, connected, and the like) are to be construed broadly and may include intermediate members between a connection of elements, relative movement between elements, direct connections, indirect connections, fixed connections, movable connections, operative connections, indirect contact, and/or direct contact. As such, joinder references do not necessarily imply that two elements are directly connected/coupled and in fixed relation to each other. Connections of electrical components, if any, may include mechanical connections, electrical connections, wired connections, and/or wireless connections, among others. Uses of “e.g.” and “such as” in the specification are to be construed broadly and are used to provide non-limiting examples of embodiments of the disclosure, and the disclosure is not limited to such examples.

While processes, systems, and methods may be described herein in connection with one or more steps in a particular sequence, such methods may be practiced with the steps in a different order, with certain steps performed simultaneously, with additional steps, and/or with certain described steps omitted.

As used herein, the term “if” is, optionally, construed to mean “when” or “upon” or “in response to determining” or “in response to detecting,” depending on the context. Similarly, the phrase “if it is determined” or “if [a stated condition or event] is detected” is, optionally, construed to mean “upon determining” or “in response to determining” or “upon detecting [the stated condition or event]” or “in response to detecting [the stated condition or event],” depending on the context.

All matter contained in the above description or shown in the accompanying drawings shall be interpreted as illustrative only and not limiting. Changes in detail or structure may be made without departing from the present disclosure.

A controller, an electronic control unit (ECU), a system, and/or a processor as described herein may include a conventional processing apparatus known in the art, which may be capable of executing preprogrammed instructions stored in an associated memory, all performing in accordance with the functionality described herein. To the extent that the methods described herein are embodied in software, the resulting software can be stored in an associated memory and can also constitute means for performing such methods. Such a system or processor may further be of the type having ROM, RAM, RAM and ROM, and/or a combination of non-volatile and volatile memory so that any software may be stored and yet allow storage and processing of dynamically produced data and/or signals.

An article of manufacture in accordance with this disclosure may include a non-transitory computer-readable storage medium having a computer program encoded thereon for implementing logic and other functionality described herein. The computer program may include code to perform one or more of the methods disclosed herein. Such embodiments may be configured to execute via one or more processors, such as multiple processors that are integrated into a single system or are distributed over and connected together through a communications network, and the communications network may be wired and/or wireless. Code for implementing one or more of the features described in connection with one or more embodiments may, when executed by a processor, cause a plurality of transistors to change from a first state to a second state. A specific pattern of change (e.g., which transistors change state and which transistors do not), may be dictated, at least partially, by the logic and/or code.

What is claimed is:

1. A track assembly, comprising:
a first track having a curved configuration;
a second track slidably connected to the first track;
a seat assembly connected to move with the second track, the seat assembly comprising a seat base and a seat back adjustable to a plurality of seat positions relative to the second track;
a lock configured to selectively lock the first track and the second track; and
a release lever configured to automatically actuate the lock.

2. The track assembly of claim 1, wherein an angular extent of the first track is at least 30 degrees and less than or equal to 120 degrees.

3. The track assembly of claim 2, wherein the angular extent of the first track is at least 40 degrees and less than or equal to 50 degrees.

4. The track assembly of claim 1, further comprising a mechanical actuator operably coupled with the release lever to automatically unlock the lock.

5. The track assembly of claim 1, further comprising an actuator operably coupled with the release lever to automatically unlock the lock, the actuator including at least one of a motor, an electromagnet, a piezoelectric material, or a pyrotechnic device.

6. The track assembly of claim 5, further comprising an electronic controller controlling operation of the actuator.

7. The track assembly of claim 6, further comprising a crash sensor connected to the electronic controller;
wherein the electronic controller is configured to operate the actuator to actuate the release lever and disengage the lock in accordance with the crash sensor detecting a crash.

8. The track assembly of claim 1, wherein the seat assembly is rotatable about a first axis via the second track sliding along the first track, and is rotatable about a second axis via a pivot rotatably coupling the seat assembly with the second track; and
the second axis is perpendicular to the second track and not parallel with a seat back axis about which the seat back is adjustable.

9. The track assembly of claim 8, further comprising a third track slidably connected to a fourth track, the fourth track having a linear configuration;
wherein the first track is mounted to the third track.

10. The track assembly of claim 1, wherein the seat back is adjustable about a seat back axis and is adjustable about a rotational axis that is offset from the seat back axis such that a recline angle of the seat back is adjustable via movement of the seat back about the seat back axis and via movement of the seat assembly about the rotational axis.
